(19) United States
(12) Patent Application Publication
(10) Pub. No.: US 2025/0378518 A1
(43) Pub. Date: Dec. 11, 2025

(54) SYSTEMS AND METHODS FOR GENERATING ADAPTIVE ARTIFICIAL INTELLIGENCE-BASED COURSE TEMPLATES USING REAL-TIME FEEDBACK

(71) Applicant: Pearson Education, Inc., Bloomington, MN (US)

(72) Inventors: Thomas K. NOVATIN, Brick, NJ (US); Chie Voy LOURNG, East Brunswick, NJ (US); Sudhakara Rao MADDINENI, Gilbert, AZ (US); Peerajirao Dongarekar PRITHVIRAJ, Pleasanton, CA (US); Shripati Shridhar NAVANAGERI, San Jose, CA (US)

(21) Appl. No.: 18/734,860

(22) Filed: Jun. 5, 2024

(51) Int. Cl. G06Q 50/20; H04L 67/306

(52) U.S. Cl. CPC G06Q 50/205; H04L 67/306

(57) ABSTRACT

Systems and methods for adaptive artificial intelligence-based course template generation. One system may include a processing system configured to: receive a request to generate a first course template for a course; identify, with an artificial intelligence (AI) engine, user data that is contextually relevant to the request; synthesize, with the AI engine, the user data to determine a set of patterns for the user data; generate, with the AI engine, a set of recommendations based on the set of patterns; generate, based on the set of recommendations, a first course template for the course; generate a first set of learning course content that adheres to the first course template for the course; and transmit the first set of learning course content to a client device for display as a learning course content rendering via a graphical user interface.

### CROSS-REFERENCE TO RELATED APPLICATIONS

N/A

### TECHNICAL FIELD

This disclosure relates to the field of systems and methods for generating course templates using real-time feedback.

### SUMMARY

The disclosed technology relates to systems and methods for generating adaptive artificial intelligence-based course templates using real-time feedback. In one example, a system for implementing adaptive artificial intelligence-based course template generation is provided. The system may include a processing system including one or more electronic processors. The processing system may be configured to receive a request to generate a first course template for a course. The processing system may be configured to identify, with an artificial intelligence (AI) engine, user data that is contextually relevant to the request. The processing system may be configured to synthesize, with the AI engine, the user data to determine a set of patterns for the user data. The processing system may be configured to generate, with the AI engine, a set of recommendations based on the set of patterns. The processing system may be configured to generate, based on the set of recommendations, a first course template for the course. The processing system may be configured to generate a first set of learning course content that adheres to the first course template for the course. The processing system may be configured to transmit, via a communication network, the first set of learning course content to a client device for display as a learning course content rendering via a graphical user interface.

In another example, a method of implementing adaptive artificial intelligence-based course template generation may be provided. The method may include receiving, with a processing system including one or more electronic processors, while a course is in progress, data associated with a first set of learning course content for the course, the first set of learning course content adhering to a first course template for the course, the first course template generated using an artificial intelligence (“AI”) engine. The method may include providing, with the processing system, the data to the AI engine in order to determine a recommended course template modification. The method may include generating, with the processing system, using the AI engine, a second course template for the course based on the recommended course template modification. The method may include generating, with the processing system, a second set of learning course content that adheres to the second course template for the course. The method may include transmitting, with the processing system via a communication network, the second set of learning course content to a client device for display as a learning course content rendering via a graphical user interface.

Another example may provide a non-transitory, computer-readable medium storing instructions that, when executed by a processing system including one or more electronic processors, perform a set of functions. The set of functions may include receiving a request to generate a first course template for a course. The set of functions may include generating, using an artificial intelligence (AI) engine, a first course template for the course, the first course template identifying a first set of learning course content that adheres to the first course template for the course. The set of functions may include transmitting the first set of learning course content for display as a learning course content rendering via a graphical user interface. The set of functions may include receiving feedback data associated with the first set of learning course content. The set of functions may include generating, with the AI engine, a second course template for the course based on the feedback data, the second course template identifying a second set of learning course content that adheres to the second course template for the course. The set of functions may include transmitting the second set of learning course content for display.

The above features and advantages of the technology disclosed herein will be better understood from the following detailed description taken in conjunction with the accompanying drawings.

### BRIEF DESCRIPTION OF THE DRAWINGS

FIG. 1 illustrates an example system level block diagram for providing the disclosed adaptive course template generation system architecture.

FIG. 2 illustrates an example system level block diagram for providing the disclosed adaptive course template generation system architecture, in accordance with various aspects of the techniques described in this disclosure.

FIG. 3 illustrates an example system level block diagram of a content management system that facilitates the disclosed adaptive course template generation system architecture, in accordance with various aspects of the techniques described in this disclosure.

FIG. 4 is a flowchart illustrating an example method for providing the disclosed adaptive course template generation system, in accordance with various aspects of the techniques described in this disclosure.

FIG. 5 illustrates another example system level block diagram for providing the disclosed adaptive course template generation system architecture.

### DETAILED DESCRIPTION

The disclosed technology will now be discussed in detail with regard to the attached drawing figures that were briefly described above. In the following description, numerous specific details are set forth illustrating the technology. It will be appreciated, however, to one skilled in the art that the technology may be practiced without many of these specific details. In other instances, well-known machines, structures, and method steps have not been described in particular detail in order to avoid unnecessarily obscuring the present inventions. Unless otherwise indicated, like parts and method steps are referred to with like reference numerals.

Many course authoring tools and approaches generally employ a one-size-fits-all approach to course design. For example, traditional course authoring tools often lack the capability to dynamically adapt course content to suit diverse learner needs. This one-size-fits-all approach can lead to suboptimal course designs and learning experiences, especially in heterogeneous student populations. Existing course structures are typically static, meaning they don't evolve based on learner feedback or performance data. This rigidity can result in content becoming outdated or less effective over time. Updating course content has traditionally been a manual and time-consuming process, often requiring significant effort from educators and instructional designers. This process can be inefficient, and slow or unable to respond to emerging educational needs. While some level of personalization is possible in modern educational tools, the tools often lack depth and real-time adaptability, limiting their effectiveness in addressing individual learning styles and needs. Many educational platforms collect vast amounts of data on student engagement and performance, but this data is often underutilized in informing course design and adaptation of content to individual learning styles, preferences, or approaches. Accordingly, some technical challenges in the field of course authoring software and systems include implementation of one-size-fits-all course design, static course structures, manual course update processes, limited personalization ability (if at all), ineffective utilization of data, and the like.

The technology disclosed herein facilitates real-time (or near real-time) data utilization. While some course authoring software tools and systems rely on static data or manual updates that are independent of any individualized context, the technology disclosed herein leverages real-time (or near real-time) data on, e.g., student interactions and content effectiveness, which allows for a more dynamic and responsive course design process. The technology disclosed herein implements a comprehensive feedback analysis approach. The technology disclosed herein may analyze a wide range of feedback, including direct student performance metrics, engagement levels with different content types, and indirect indicators of content effectiveness. Such a holistic approach is a significant advancement over course authoring approaches or systems that may only consider limited data points. The technology disclosed herein provides AI-driven adaptive course templates. By implementing AI, the technology disclosed herein has the ability to synthesize this data and generate various course templates that not only reflect a current state of data that has been collected, but can adapt over time as additional feedback. The technology disclosed herein continuously refines these templates based on ongoing feedback, ensuring that the templates remain effective and relevant. The technology disclosed herein provides personalized learning paths. The technology disclosed herein may tailor course content to individual or group learning styles and generate equivalent templates for the same course and needs, which represents a technical improvement over other course authoring software tools and approaches, which may not provide a learner-centric approach as provided by the technology disclosed herein.

The technology disclosed herein may use predictive analytics for course design. By employing advanced machine learning algorithms, the technology disclosed herein can predict which types of content and structures are likely to be most effective for future courses, based on, e.g., historical data and trends.

The technology disclosed herein may provide for adaptive AI-based course template generation using real-time (or near real-time) feedback. For instance, in some configurations, an AI engine may facilitate or otherwise implement real-time (or near real-time) adaptation or personalization, as described in greater detail herein. For instance, the AI engine may adapt course content, including course templates, in real-time (or near real-time), which may offer personalized learning paths for an individual learner user, a group of learner users, etc. For instance, when a student is struggling with a concept, the technology disclosed herein can dynamically adjust or revise a course template by automatically introducing supplementary materials, adjusting a difficulty level of assessments, etc.

The technology disclosed herein may enhance learning outcomes by providing personalized experiences, improving comprehension and retention for learners. The technology disclosed herein may increase accessibility to education by catering to diverse learning needs and abilities. Educators benefit from data-driven insights, enabling them to improve teaching strategies and professional development. The technology disclosed herein provides for scalability across various educational offerings, disciplines, and platforms, from K-12 to professional training, which amplifies its impact. With its ability to automatically create assignments and questions, the technology disclosed herein provides a significant competitive edge in the educational technology market. The technology disclosed herein provides advanced personalization that enhances learning outcomes by tailoring content to individual student needs. The technology disclosed herein advantageously improves efficiency in automating course design as well as improving quality and performance of automated course design. which reduces educators' workload, a major advantage for institutions. The technology disclosed herein aligns with trends towards online and blended learning, and, as such, the technology disclosed herein meets a demand in modern education while also enhancing student engagement and satisfaction.

Additionally, the technology disclosed herein addresses privacy concerns related to student data, including, e.g., maintaining trust and compliance with educational standards and regulations. The technology disclosed herein provides a technical improvement in data security as it relates to the privacy concerns of student data as the technology disclosed herein provides for a more personalized and efficient learning environment while also maintaining trust and compliance with educational standards and regulations related to student data privacy concerns. Additionally, the technology disclosed herein aligns with an evolving need of modern education by enhancing the reachability of quality content through recommendation as well as reducing manual steps for authoring the course, which in turn improves outcomes for the students and maintains privacy of a student’s data.

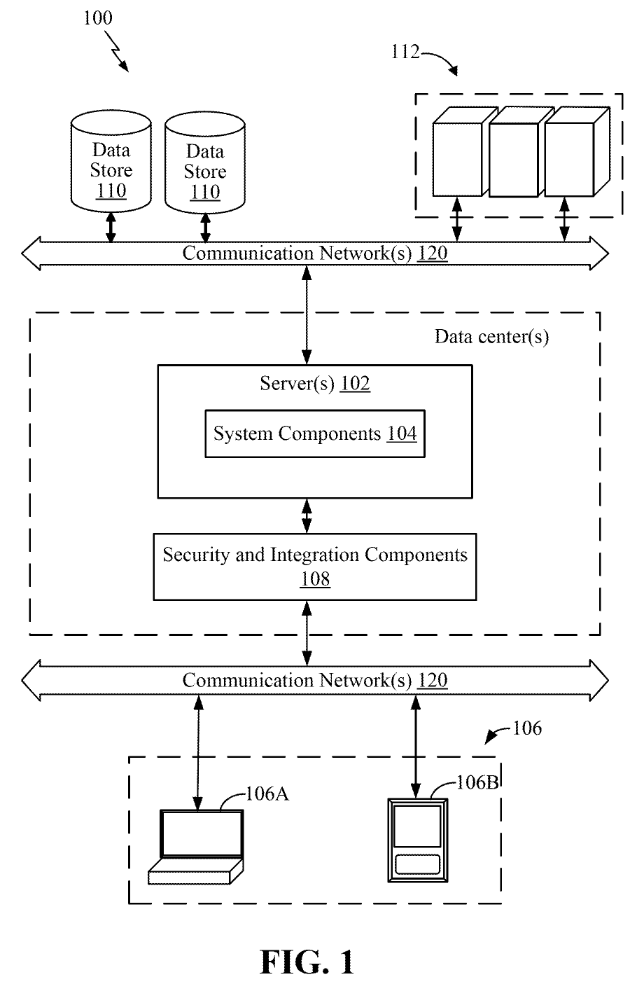

FIG. 1 illustrates an example of a distributed computing environment 100. In some examples, the distributed computing environment 100 may include one or more server(s) 102 (e.g., data servers, computing devices, computers, etc.), one or more client computing devices 106, and other components that may implement certain embodiments and features described herein. Other devices, such as specialized sensor devices, etc., may interact with the client computing device(s) 106 and/or the server(s) 102. The server(s) 102, the client computing device(s) 106, or any other devices may be configured to implement a client-server model or any other distributed computing architecture. In an illustrative example, the client devices 106 may include a first client device 106A and a second client device 106B. The first client device 106A may correspond to a first user in a class and the second client device 106B may correspond to a second user in the class or another class.

In some examples, the server(s) 102, the client computing device(s) 106, and any other disclosed devices may be communicatively coupled via one or more communication network(s) 120. The communication network(s) 120 may be any type of network known in the art supporting data communications. In some examples, the communication network 120 may be a local area network (LAN; e.g., Ethernet, Token-Ring, etc.), a wide-area network (e.g., the Internet), an infrared or wireless network, a public switched telephone networks (PSTNs), a virtual network, etc. The communication network 120 may use any available protocols, such as, e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

The configurations illustrated in FIGS. 1 and/or 2 are respective examples of a distributed computing system and are not intended to be limiting. The subsystems and components within the server(s) 102 and the client computing device(s) 106 may be implemented in hardware, firmware, software, or combinations thereof. Various different subsystems and/or the system components 104 may be implemented on the server 102. Users operating the client computing device(s) 106 may initiate one or more client applications to use services provided by these subsystems and components. Various different system configurations are possible in different distributed computing environments 100 and content distribution networks. The server 102 may be configured to run one or more server software applications or services, for example, web-based or cloud-based services, to support content distribution and interaction with the client computing device(s) 106. Users operating the client computing device(s) 106 may in turn utilize one or more client applications (e.g., virtual client applications) to interact with the server 102 to utilize the services provided by these components. The client computing device(s) 106 may be configured to receive and execute client applications over the communication network(s) 120. Such client applications may be web browser-based applications and/or standalone software applications, such as mobile device applications. The client computing device(s) 106 may receive client applications from the server 102 or from other application providers (e.g., public or private application stores).

As illustrated in FIG. 1, various security and integration components 108 may be used to manage communications over the communication network(s) 120 (e.g., a file-based integration scheme, a service-based integration scheme, etc.). In some examples, the security and integration components 108 may implement various security features for data transmission and storage, such as, e.g., authenticating users or restricting access to unknown or unauthorized users. In some examples, the security and integration components 108 may include dedicated hardware, specialized networking components, and/or software (e.g., web servers, authentication servers, firewalls, routers, gateways, load balancers, etc.) within one or more data centers in one or more physical location(s) and/or operated by one or more entities, and/or may be operated within a cloud infrastructure. In various implementations, the security and integration components 108 may transmit data between the various devices in the distribution computing environment 100 (e.g., in a content distribution system or network). In some examples, the security and integration components 108 may use secure data transmission protocols and/or encryption (e.g., Hypertext Transfer Protocol Secure (HTTPS), Secure Shell (SSH), Virtual Private Network (VPN), File Transfer Protocol (FTP), Secure File Transfer Protocol (SFTP), and/or Pretty Good Privacy (PGP) encryption) for data transfers, etc.).

In some examples, the security and integration components 108 may implement one or more web services (e.g., cross-domain and/or cross-platform web services) within the distribution computing environment 100, and may be developed for enterprise use in accordance with various web service standards (e.g., the Web Service Interoperability (WS-I) guidelines). In an example, some web services may provide secure connections, authentication, and/or confidentiality throughout the network using technologies such as SSL, TLS, HTTP, HTTPS, WS-Security standard (providing secure SOAP messages using XML encryption), etc. In some examples, the security and integration components 108 may include specialized hardware, network appliances, and the like (e.g., hardware-accelerated SSL and HTTPS), possibly installed and configured between one or more of the servers 102 and other network components. In such examples, the security and integration components 108 may thus provide secure web services, thereby allowing any external devices to communicate directly with the specialized hardware, network appliances, etc.

The distribution computing environment 100 may further include one or more data stores 110, as illustrated in FIG. 1. In some examples, the data store(s) 110 may include, and/or reside on, one or more back-end servers 112, operating in one or more data center(s) in one or more physical locations. In such examples, the data store(s) 110 may communicate data between one or more devices, such as those connected via the communication network(s) 120. In some cases, the data store(s) 110 may be managed as resources within a cloud infrastructure. In some cases, the data store(s) 110 may reside on a non-transitory storage medium within one or more of the servers 102. In some examples, the data store(s) 110 and the back-end server(s) 112 may reside in a storage-area network (SAN). In addition, access to the data store(s) 110, in some examples, may be limited and/or denied based on the processes, user credentials, network access control lists (ACL), or security groups, and/or devices attempting to interact with the data store(s) 110.

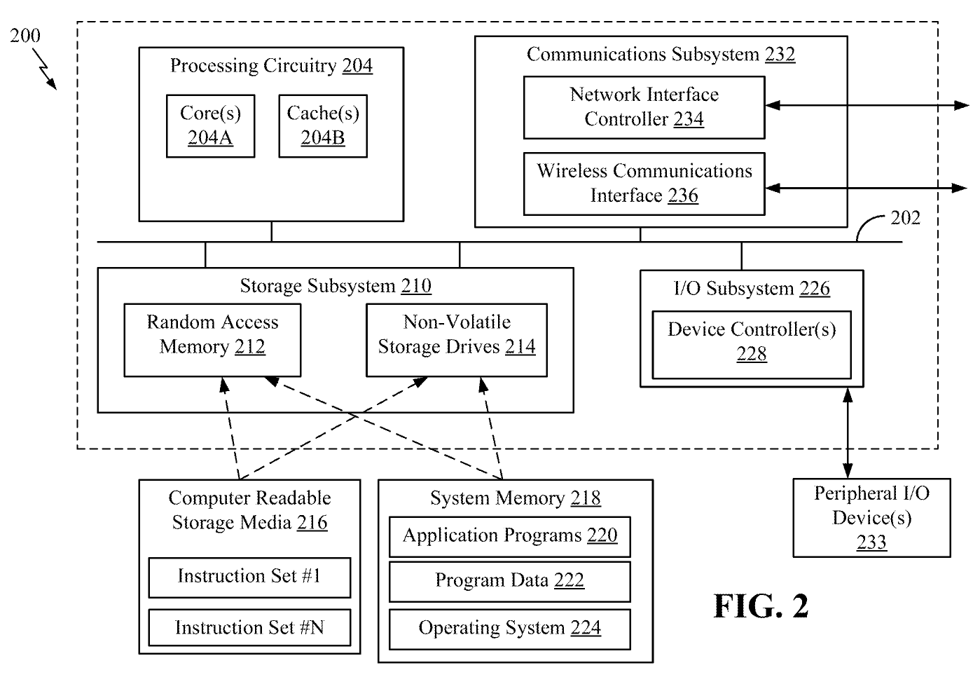

With reference now to FIG. 2, a block diagram of an example computing system 200 is illustrated. The computing system 200 (e.g., one or more computers) may correspond to any one or more of the computing devices or servers of the distribution computing environment 100, or any other computing devices or servers described herein. In an example, the computing system 200 may represent an example of the server(s) 102 and/or of the back-end server(s) 112 of the distribution computing environment 100. In another example, the computing system 200 may represent an example of the client computing device(s) 106 of the distribution computing environment 100. In some examples, the computing system 200 may represent a combination of one or more computing devices and/or servers of the distribution computing environment 100.

In some examples, the computing system 200 may include processing circuitry 204, such as one or more processing unit(s), electronic processor(s), etc. In some examples, the processing circuitry 204 may communicate (e.g., interface) with a number of peripheral subsystems via a bus subsystem 202. These peripheral subsystems may include, for example, a storage subsystem 210, an input/output (I/O) subsystem 226, and a communications subsystem 232.

In some examples, the processing circuitry 204 may be implemented as one or more integrated circuits (e.g., a micro-processor or microcontroller). In an example, the processing circuitry 204 may control the operation of the computing system 200. The processing circuitry 204 may include single core and/or multicore (e.g., quad core, hexa-core, octo-core, ten-core, etc.) processors (represented in FIG. 2 by reference numeral 204A) and processor caches (represented in FIG. 2 by reference numeral 204B). The processing circuitry 204 may execute a variety of resident software processes embodied in program code, and may maintain multiple concurrently executing programs or processes. In some examples, the processing circuitry 204 may include one or more specialized processors, (e.g., digital signal processors (DSPs), outboard, graphics application-specific, and/or other processors).

In some examples, the bus subsystem 202 provides a mechanism for communication between the various components and subsystems of the computing system 200. Although the bus subsystem 202 is illustrated schematically as a single bus, alternative embodiments of the bus subsystem 202 may utilize multiple buses. In some examples, the bus subsystem 202 may include a memory bus, memory controller, peripheral bus, and/or local bus using any of a variety of bus architectures (e.g., Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

In some examples, the I/O subsystem 226 may include one or more device controller(s) 228 for one or more user interface input devices and/or user interface output devices, possibly integrated with the computing system 200 (e.g., integrated audio/video systems, and/or touchscreen displays), or may be separate peripheral devices (e.g., the peripheral I/O devices 233 illustrated in FIG. 2), which are attachable/detachable from the computing system 200. Input may include keyboard, touchpad, or mouse input, audio input (e.g., spoken commands), motion sensing, gesture recognition (e.g., eye gestures), etc. As non-limiting examples, input devices may include a keyboard, a pointing device (e.g., mouse, trackball, and associated input), a touchpad, a touch screen, a scroll wheel, a click wheel, a dial, a button, a switch, a keypad, an audio input device, a voice command recognition system, a microphone, a three dimensional (3D) mouse, a joystick, a pointing stick, a gamepad, a graphic tablet, a speaker, a digital camera, a digital camcorder, a portable media player, a webcam, an image scanner, a fingerprint scanner, a barcode reader, a 3D scanner, a 3D printer, a laser rangefinder, an eye gaze tracking device, a medical imaging input device, a MIDI keyboard, a digital musical instrument, and the like. In general, use of the term “output device” is intended to include all possible types of devices and mechanisms for outputting information from the computing system 200, such as to a user (e.g., via a display device) or any other computing system, such as a second computing system 200. In an example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or may include one or more non-visual display subsystems and/or non-visual display devices, such as audio output devices, etc. As non-limiting examples, output devices may include, indicator lights, monitors, printers, speakers, headphones, automotive navigation systems, plotters, voice output devices, modems, etc.

In some examples, the computing system 200 may include one or more storage subsystems 210, including hardware and software components used for storing data and program instructions, such as system memory 218 and computer-readable storage media 216. In some examples, the system memory 218 and/or the computer-readable storage media 216 may store and/or include program instructions that are loadable and executable on the processor(s) 204. In an example, the system memory 218 may load and/or execute an operating system 224, program data 222, server applications, application program(s) 220 (e.g., client applications), Internet browsers, mid-tier applications, etc. In some examples, the system memory 218 may further store data generated during execution of these instructions.

In some examples, the system memory 218 may be stored in volatile memory (e.g., random-access memory (RAM) 212, including static random-access memory (SRAM) or dynamic random-access memory (DRAM)). In an example, the RAM 212 may contain data and/or program modules that are immediately accessible to and/or operated and executed by the processing circuitry 204. In some examples, the system memory 218 may also be stored in non-volatile storage drives 214 (e.g., read-only memory (ROM), flash memory, etc.). In an example, a basic input/output system (BIOS), containing the basic routines that help to transfer information between elements within the computing system 200 (e.g., during start-up), may typically be stored in the non-volatile storage drives 214.

In some examples, the storage subsystem 210 may include one or more tangible computer-readable storage media 216 for storing the basic programming and data constructs that provide the functionality of some embodiments. In an example, the storage subsystem 210 may include software, programs, code modules, instructions, etc., that may be executed by the processing circuitry 204, in order to provide the functionality described herein. In some examples, data generated from the executed software, programs, code, modules, or instructions may be stored within a data storage repository within the storage subsystem 210. In some examples, the storage subsystem 210 may also include a computer-readable storage media reader connected to the computer-readable storage media 216.

In some examples, the computer-readable storage media 216 may contain program code, or portions of program code. Together and, optionally, in combination with the system memory 218, the computer-readable storage media 216 may comprehensively represent remote, local, fixed, and/or removable storage devices plus storage media for temporarily and/or more permanently containing, storing, transmitting, and/or retrieving computer-readable information. In some examples, the computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information and which can be accessed by the computing system 200. In an illustrative and non-limiting example, the computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media.

In some examples, the computer-readable storage media 216 may include, but is not limited to, Zip® drives, flash memory cards, universal serial bus (USB) flash drives, secure digital (SD) cards, DVD disks, digital video tape, and the like. In some examples, the computer-readable storage media 216 may include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magneto-resistive RAM (MRAM) SSDs, and hybrid SSDs that use a combination of DRAM and flash memory-based SSDs. The disk drives and their associated computer-readable media may provide non-volatile storage of computer-readable instructions, data structures, program modules, and other data for the computing system 200.

In some examples, the communications subsystem 232 may provide a communication interface from the computing system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally, and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 232 also may include radio frequency (RF) transceiver components for accessing wireless voice and/or data networks (e.g., using cellular telephone technology, advanced data network technology, such as 3G, 4G, 5G or EDGE (enhanced data rates for global evolution), Wi-Fi (IEEE 802.11 family standards, or other mobile communication technologies, or any combination thereof), global positioning system (GPS) receiver components, and/or other components.

In some examples, the communications subsystem 232 may also receive input communication in the form of structured and/or unstructured data feeds, event streams, event updates, and the like, on behalf of one or more users who may use or access the computing system 200. In an example, the communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, the communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). In some examples, the communications subsystem 232 may output such structured and/or unstructured data feeds, event streams, event updates, and the like to one or more data stores that may be in communication with one or more streaming data source computing systems (e.g., one or more data source computers, etc.) coupled to the computing system 200. The various physical components of the communications subsystem 232 may be detachable components coupled to the computing system 200 via a computer network (e.g., a communication network 120), a FireWire® bus, or the like, and/or may be physically integrated onto a motherboard of the computing system 200. In some examples, the communications subsystem 232 may be implemented in whole or in part by software.

Due to the ever-changing nature of computers and networks, the description of the computing system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

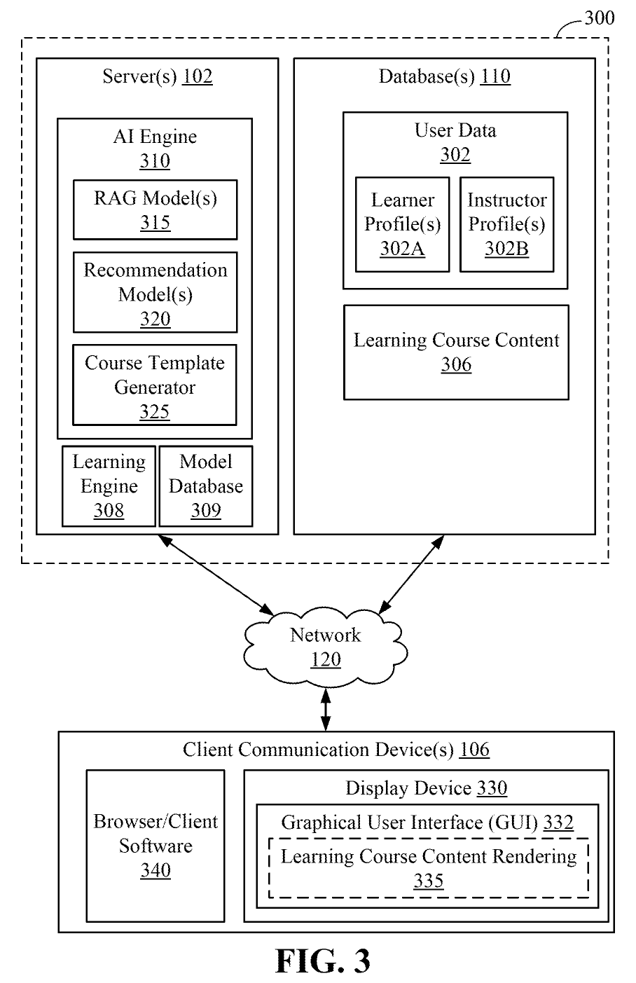

FIG. 3 illustrates a system level block diagram of a content assessment and development system 300. In some examples, the content assessment and development system 300 may include one or more database(s) 110, also referred to as data stores herein, one or more servers 102, or a combination thereof. The database(s) 110 may include a plurality of user data 302 (e.g., a set of user data items). In such examples, the content assessment and development system 300 may store and/or manage the user data 302 in accordance with one or more of the various techniques of the disclosure. In some examples, the user data 302 may include user responses, user history, user scores, user performance, user preferences, and the like. Alternatively, or in addition, in some configurations, the user data 302 may include one or more recordings, as described in greater detail herein.

As illustrated in FIG. 3, in some configurations, the user data 302 may be include one or more learner profiles 302A, one or more instructor profiles 302B, or a combination thereof. A learner profile 302A may be related to or otherwise associated with a learner user, such as, e.g., a student. An instructor profile 302B may be related to or otherwise associated with an instructor user, such as, e.g., a teacher, an administrator, etc. As one example, an instructor user may include a user that teaches or develops educational content while a learner user may include a user that interacts with the developed educational content to learn a skill, a learning objective, etc.

The learner profile 302A may include user data 302 specific to a particular learner user. For instance, the learner profile 302A may include user responses, user history, user scores, user performance, user preferences, and the like for a particular learner user. As one example, the learner profile 302A may include information or data relating to how a learner user interacts (or engages) with course content or materials, such as, e.g., clicks, dwell time, time duration on a particular content section or learning objective, quiz responses, or the like. As another example, the learner profile 302A may include information or data relating to performance metrics for a learner user, such as, e.g., assessment performance or scores, including, e.g., quiz or test scores. As yet another example, the learner profile 302A may include information or data relating to qualitative feedback provided by the learner user, such as, e.g., survey responses, forum discussions, unsolicited feedback, or the like. As yet another example, the learner profile 302A may include information or data relating to content usage patterns for a learner user, such as, e.g., a popularity or effectiveness of different types of content, including, e.g., videos, text, illustrations or drawings, animations, audio, interactive elements, etc.

Accordingly, in some configurations, the user data 302 included in a learner profile 302A may be actively or intentionally provided by a learner user (e.g., qualitative feedback, etc.). Alternatively, or in addition, in some configurations, the user data 302 included in a learner profile 302A may be inactively or unintentionally provided by a learner user (e.g., content usage patterns, content interaction or engagement, etc.). As such, in some configurations, the content assessment and development system 300 may develop and maintain (or otherwise manage) individual learner profiles 302A for each learner or student. The content assessment development system 300 may develop and maintain the learner profiles 302A based on the learner user’s interactions with course materials, assessment performances, direct feedback, and the like. For instance, the content assessment and development system 300 may update (continuously or intermittently) the learner profile(s) 302A as additional user data 302 becomes available (e.g., a learner user submits new qualitative feedback, completes a new assessment, etc.). The content assessment and development system 300 may aggregate user data 302 over time, thus capturing a comprehensive view of each learner user’s learning journey, preferences, strengths, weaknesses, etc. In some configurations, the content assessment and development system 300 may provide instructor user(s) with detailed insights into each learner user’s learning process, aiding in more targeted and effective teaching approaches. As such, the content assessment and development system 300 may facilitate or implement dynamic learner profile design, including, e.g., the creation of learner profile(s) 302A, the aggregation and analysis of data for inclusion in learner profile(s) 302A, and/or the provision of feedback to instructor users as described herein.

The instructor profile 302B may include user data 302 specific to a particular instructor user. For instance, the instructor profile 302B may include a list of educational courses taught by the instructor, teaching preferences, a class list of learner users, teaching history, recordings, and the like for a particular instructor user. As one example, the instructor profile 302B may include information or data relating to an instructor user’s desired learning duration, such as, e.g., a course length, a learning objective or topic length (e.g., how long an instructor user wants to spend teaching fractions, long division, etc.). As another example, the instructor profile 302B may include information or data relating to an instructor user’s preferred difficulty levels for a specific course (e.g., a Literature Course taught on Tuesdays at 6pm, “Course No. 1234,” etc.), a learning objective, topic, or material (e.g., fractions, verb tenses, “Great Expectations,” etc.), a type of course (e.g., College Algebra courses, Philosophy courses, etc.), or the like. As yet another example, the instructor profile 302B may include information or data relating to an instructor user’s assessment preferences, including, e.g., a difficulty level, a frequency (e.g., weekly, monthly, after completing specific learning objectives, topics, or materials, one or more pre-selected dates, etc.), a number (e.g., 10 assessments per course), etc. As yet another example, the instructor profile 302B may include information or data relating to an instructor user’s teaching goals or outcomes, including, e.g., learner users achieving a skill proficiency necessary for obtaining a professional certification or license (e.g., a human resources certification, a nursing certification, a CPA certification, etc.), learner users achieving a passing score on an advanced placement examination (e.g., AP Literature, AP Biology, etc.), learner users performance metrics indicating the learner-users readiness to advance (e.g., to a subsequent grade level, a subsequent difficulty level, etc.), learner users ability to performance metrics indicating a proficiency with one or more learning objectives or topics (e.g., fractions, multiplication, chemical reactions, balancing equations, etc.), and/or the like.

In some configurations, the instructor profile 302B (i.e., the user data 302 included herein) may include one or more recordings. The recording(s) may be in various formats. For instance, the recording(s) may be an audio recording, a video recording, etc. The recording may be a previous recording of an instructor user. For instance, the recording may be of a previous course (or portion thereof). As one example, the recording may be a recording of the instructor user teaching a learning objective (e.g., how to balance an equation, how to simplify fractions, how to use the quadratic equation, etc.). As another example, the recording may be a recording of the instructor user teaching a course (e.g., the course in its entirety or a portion or portions thereof). In some instances, the recording(s) may be of the instructor user teaching a course (or portion thereof) to one or more students (e.g., during a course having one or more students enrolled). Alternatively, or in addition, in some configurations, the recording(s) may be of the instructor user teaching a course (or portion thereof) without any students actively enrolled in the course (or portion thereof). In such instances, the instructor user may make the recording(s) such that the recording(s) may be viewed on demand by one or more students.

The content assessment and development system 300 may develop and maintain (or otherwise manage) the instructor profile(s) 302B. For instance, as described in greater detail herein, the content assessment and development system 300 may analyze the user data 302 included in the instructor profile(s) 302B to determine and understand educational objectives and constraints set by a particular instructor user (e.g., one or more course criteria). As one example, when an instructor user prefers a more in-depth exploration of certain topics, the content assessment and development system 300 may utilize this knowledge (or preference) when developing content, such as, e.g., one or more course templates, as described in greater detail herein. As such, in some configurations, the content assessment and development system 300 may facilitate the integration of instructor-based inputs (e.g., preferences, learning objectives, course criteria, etc.) in the development and generation of content, such as, e.g., course templates as described herein.

In addition, the database(s) 110 may include learning course content 306 (e.g., content resources or data packets). The learning course content 306 may include content associated with a learning course (e.g., lessons, units, screens, learning content components, coursework elements, etc.). For example, the learning course content 306 may include webpages, presentations, papers (e.g., electronic publications), videos, charts, graphs, books, written work, figures, images, graphics, recordings, training materials, presentations, plans, syllabi, reviews, evaluations, interactive programs, interactive simulations, course models, course outlines, various training interfaces, course templates, assessments, etc. In some instances, the learning course content 306 may be developed or authored by a third-party user or entity. Alternatively, or in addition, in some instances, the learning course content 306 may include content developed or generated by or for an instructor user. As one example, the learning course content 306 may include the course template(s) as described herein. As another example, the learning course content 306 may include the one or more recording(s) included in the instructor profile(s) 302B. Following this example, in some instances, the one or more recording(s) included in the instructor profile(s) 302B may be presented to (or otherwise provided) as learning course content to a learner user (e.g., in accordance with a course template), as described in greater detail herein.

Further, as illustrated in FIG. 3, the server(s) 102 may include a learning engine 308 and a model database 309. In some configurations, the learning engine 308 develops one or more models using one or more machine learning functions. Machine learning functions are generally functions that allow a computer application to learn without being explicitly programmed. In particular, the learning engine 308 is configured to develop an algorithm or model based on training data. As one example, to perform supervised learning, the training data includes example inputs and corresponding desired (for example, actual) outputs, and the learning engine 308 progressively develops a model that maps inputs to the outputs included in the training data. As another example, to perform self-supervised learning (“SSL”), a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data). Machine learning performed by the learning engine 308 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, etc. These approaches allow the learning engine 308 to ingest, parse, and understand data and progressively refine models.

Models generated by the learning engine 308 can be stored in the model database 309. As illustrated in FIG. 3, the model database 309 may be included in the server(s) 102. It should be understood, however, that, in some configurations, the model database 309 may be included in one or more separate devices accessible by the server(s) 102 of FIG. 1 (including a remote database, and the like). For instance, in some examples, the learning engine 308, the model database 309, or a combination thereof may be included in one or more of the databases 110, the clients 106, etc.

As also illustrated in FIG. 3, the server(s) 102 may include an AI engine 310. In some examples, the AI engine 310 may include one or more generative AI models. In other examples, the AI engine 310 may include one or more recurrent neural networks (RNNs), convolutional neural networks (CNNs), transformer models, sequence-to-sequence models, word embeddings, memory networks, graph neural networks or any other suitable artificial intelligence model. For instance, in some configurations, the AI engine 310 may utilize one or more machine learning models or algorithms to process and analyze data (e.g., the user data 302 included in the learner profile(s) 302A, the instructor profile(s) 302B, or a combination thereof, the learning course content 306, etc.). The AI engine 310 may generate a comprehensive understanding of a course, including, e.g., the learning objective(s) of the course. In some instances, the AI engine 310 may generate a comprehensive understanding of a course by identifying patterns and correlations between student behaviors, learning outcomes, content types, instructor preferences or teaching style, etc. The AI engine 310 may adapt its analysis as more data is collected or available (e.g., feedback data).

In some examples, the AI engine 310 may analyze the recording(s) of an instructor user (as input) to determine (or extract) a teaching style for the instructor user. A teaching style may be characterized by one or more characteristics of an instructor user that describe how an instructor user ultimately teaches or otherwise provides instruction to learner(s). The AI engine 310 may analyze the recording(s) to recognize such characteristics and identify patterns within the recording(s). The AI engine 310 may then determine (or learn) a teaching style for a particular instructor user based, e.g., on patterns identified within the recording(s). Accordingly, while in some instances the instructor profile 302B may be compiled by an instructor user specifying various preferences (e.g., an instructor selecting or otherwise indicating a preference or teaching style), in other instances, the AI engine 310 may compile the instructor profile 302B based on the analysis of the recording(s). For instance, in some configurations, the AI engine 310 may determine a particular teaching style for a particular instructor user. The AI engine 310 may automatically update a corresponding instructor profile 302B for that particular instructor user such that the corresponding instructor profile 302B reflects the teaching style recognized in the recording(s).

As described in greater detail herein, the AI engine 310 may utilize the teaching style when determining (or otherwise generating) course templates such that the course template(s) for a particular instructor user aligns with a teaching style (a learned teaching style) of that particular instructor. As one example, the AI engine 310 may analyze a recording and determine that the instructor user utilizes a Socratic method when teaching (e.g., a Socratic teaching style). Following this example, the AI engine 310 may generate a course template that aligns with a Socratic teaching style. As another example, the AI engine 310 may analyze a recording and determine that the instructor user utilizes class participation or interaction with the student(s) being taught (e.g., an interactive teaching style). Following this example, the AI engine 310 may generate a course template that aligns with an interactive teaching style (e.g., the course template may include learning course content that promotes class participation or interaction). As yet another example, the AI engine 310 may analyze a recording and determine that the instructor user regularly works through example problems when teaching (e.g., an example-based teaching style). Following this example, the AI engine 310 may generate a course template that aligns with an example-based teaching style (i.e., the course template may include, as learning course content, a large number of example problems to be worked through as part of teaching a course or portion thereof). As still another example, the AI engine 310 may analyze a recording and determine that the instructor user utilizes media (e.g., videos) when teaching. Following this example, the AI engine 310 may generate a course template that includes videos.

In the example illustrated in FIG. 3, the AI engine 310 may include a retriever-augmented generation (RAG) model 315. The RAG model 315 may combine the strength of a retriever model to fetch relevant data and a generator model to synthesize the relevant data. Accordingly, as described in greater detail herein, the AI engine 310 may invoke the RAG model 315 to fetch relevant data from the database(s) 110, such as, e.g., the user data, the learning course content 306, etc., and to synthesize the relevant data. The AI engine 310 (via, e.g., the RAG model 315) may synthesize the relevant data by accessing (or otherwise receiving) the relevant data from multiple sources (e.g., the databases 110) and integrating the relevant data in order to identify or determine relationships, patterns, themes, etc. for the relevant data such that patterns of agreement, convergence, divergence, discrepancy, etc. may be determined. As such, in some configurations, the AI engine 310 (via, e.g., the RAG model 315) may perform more than mere data aggregation with respect to the relevant data. For instance, as noted above, the AI engine 310 (via, e.g., the RAG model 315) may integrate the relevant data to determine patterns for the relevant data. Such integration allows the technology disclosed herein to identify and fetch contextually relevant educational content and data from a broad dataset, which may span multiple database(s) 110. The ability to identify and fetch contextually relevant educational content and data from a broad dataset enhances the quality and relevance of the functionality or analysis performed by the technology disclosed herein. Additionally, in some instances, performing the functionality or analysis with respect to contextually relevant educational content and data (as opposed to a larger dataset that includes all available data) may improve the overall processing or performance or reduce storage utilized by the technology disclosed herein.

In some configurations, the AI engine 310 may include a recommendation model 320. The recommendation model 320 may be a sophisticated AI-driven recommendation model or algorithm. The AI engine 310 may invoke the recommendation model 320 to analyze data (e.g., the user data 302) and generate recommendations based on the analysis of the data (e.g., the user data 302). For instance, in some configurations, the recommendation model 320 may access (or otherwise receive) the patterns for the relevant data (as determined via, e.g., the RAG model 315). As described in greater detail herein, the recommendation model 320 may utilize (or analyze) the patterns determined by the RAG model 315 in order to determine or generate one or more recommendations. Accordingly, in some instances, the RAG model 315 and the recommendation model 320 may operate or function serially. In some configurations, the recommendation(s) determined by the recommendation model 320 may include one or more predictions. A prediction determined by the recommendation model 320 may relate to, e.g., a content type, a teaching methodology or style (e.g., a teaching methodology likely to yield the best learning outcomes), etc. For instance, the recommendation or predictions may provide suggestions for optimizing learning outcomes.

Accordingly, in some configurations, the AI engine 310 may utilize advanced machine learning techniques, such as, e.g., deep learning or natural language processing, to understand complex patterns in, e.g., student learning or instructor preferences. For instance, in some configurations, the AI engine 310 may be equipped to handle complex patterns that involves coordinating across multiple systems, which may be managed by employing techniques such as, e.g., chain of thought (COT) prompting, reasoning and acting (ReACT), or agent function invocations (e.g., as opposed to simpler patterns, such as, e.g., querying large language models (LLMs) and providing responses based on output(s) of the LLMs). The combined functionality and power of the RAG model 315 and the recommendation model 320 enables a more nuanced analysis of the relevant data, including, e.g., relevant user data 302, relevant learning course content 306, etc. For instance, as described herein, the technology disclosed herein may leverage the power of RAG to combine with data analytics from various sources, such as, e.g., student interaction, instructor interaction, etc., to create, e.g., assignments and the rest of the template, the content relevance, student feedback, etc. as a continuous feedback loop, which enables training with more contextual and relevant data such that performance of a model improves as the model interacts with more training data.

By enabling a more nuanced analysis, the technology disclosed herein provides technical enhancements or advantages by creating a more robust and useful understanding of a course (e.g., learning objective(s) of the course). For instance, the technology disclosed herein may become more adept at identifying subtle correlations or patterns between, e.g., student behaviors, learning outcomes, content types, etc., enhancing an ability to adapt an analysis as more data is collected (e.g., feedback data) and, in some instances, feed that data back into instructor authoring functionality or tools to further automate course creation. For instance, in some configurations, the AI engine 310 may determine an impact that an instructor preference (or course criterion) may have on (or is presently having on) a learner user (or group thereof). For example, in some instances, an instructor preference or course criterion may hinder a learner user performance or ability to learn. As one specific example, when an instructor prefers a lecture approach with limited class participation, a student that excels in an interactive learning environment may struggle more than a student that does not prefer an interactive learning environment.

In some examples, as described herein, the AI engine 310 may interact with various data sources that allows leveraging COT processing across different data sources, before providing a relevant recommendation for an instructor template creation. As one example, an instructor may be trying to find the best reading assignment, which triggers a call to the AI engine 310 (through RAG), which may, in turn, tap into multiple internal data sources through a vectorization process. The AI engine 310 may be able to stitch the relevant information across different sources through this process in order to decide the highest ranked assignment that is used in the template using a search ranking process.

As illustrated in FIG. 3, in some configurations, the AI engine 310 may include (or otherwise implement) a course template generator 325. As described in greater detail herein, the AI engine 310 may invoke the course template generator 325 in order to dynamically generate a course template. As used herein, a course template may be an outline or plan for teaching a course or component thereof (e.g., a course architecture). The course template may provide a schedule or plan for teaching various components of a course, including, e.g., units, lessons, assessments, etc. An instructor may utilize a course template as a course or lesson plan for instructing one or more learner users. As used herein, a course template may exist at a course level, a unit level, a lesson level, etc. For instance, the course template may be for a course in its entirety. Alternatively, or in addition, the course template may be for one or more particular units, lessons, or the like.

A course template may include temporal information for a course, such as, e.g., a course or course component duration (e.g., a six-week course), an order or sequence of course components (e.g., an order or sequence for teaching various units or topics of the course), etc. For example, the course template may indicate an order or sequence of course components (e.g., a suggested order of units, lessons, assessments, etc. that learn users should follow). The course template may include content information for a course, such as, e.g., a particular resource or source of content (or portion thereof) (e.g., the learning course content 306), a content type (e.g., lecture, video, audio, assessment, example problems, etc.), a presentation or delivery format (e.g., in-person, virtual, etc.), a content format (e.g., digital or electronic), etc. For example, the course template may identify a particular electronic textbook (e.g., an eTextbook) for the course (or portion thereof). As another example, the course template may identify a particular recording for the course (or portion thereof). The course template may include teaching style or methodology information for a course (or component thereof), such as, e.g., a recommended or suggested type of teaching methodology (e.g., a Socratic method teaching style, an interactive teaching style, an example-based teaching style, etc.), etc. As one example, the course template may indicate an interactive or hands-on teaching style or methodology for a laboratory related unit of a course. As another example, the course template may indicate an independent teaching methodology for a vocabulary unit of a language arts course.

The AI engine 310 (via, e.g., the course template generator 325) may generate a course template based on the outcome of the RAG model 315, the recommendation model 320, or a combination thereof. In some examples, the AI engine 310 (via, e.g., the course template generator 325) may generate a course template that implements one or more of the recommendations (or predictions) from the recommendation model 320. As one example, the AI engine 310 (via, e.g., the course template generator 325) may generate a course template that proposes an optimal mix of content types, structures, assessment methods, etc.

In some configurations, the course template may be dynamic (e.g., is not static). The course template may evolve continuously as the AI engine 310 learns from ongoing student interactions, feedback, etc. For instance, as described in greater detail herein, the AI engine 310 may dynamically adjust or update a course template as new or additional data (e.g., additional contextually relevant user data) becomes available (or otherwise accessible) by the RAG model 315, the recommendation model 320, the course template generator 325, or a combination thereof. Accordingly, in some configurations, the course template generator 325 may generate an updated or revised course template (e.g., an updated or revised version of the course template may be an updated or revised version of a previously generated course template). Alternatively, in some configurations, the course template generator 325 may generate a new course template (e.g., the course template may be a newly generated or created course template).

As noted herein, the AI engine 310 may utilize (or invoke) one or more machine learning models as part of performing the functionality described herein. As such, in some configurations, the RAG model 315, the recommendation model 320, the course template generator 325, another model utilized by the AI engine 310 may be developed via the learning engine 308, stored in the model database 309, or a combination thereof. As described in greater detail herein, in some instances, the AI engine 310 may receive feedback (also referred to herein as feedback data). The feedback data may include, e.g., additional information for one or more learner users (e.g., additional content usage patterns, performance metrics, qualitative feedback, etc.), one or more instructor users (e.g., additional instructor preferences, course criteria, or input), or a combination thereof. Alternatively, or in addition, in some configurations, the feedback may include additional, new, or modified learning course content 306 (e.g., a new assessment published by a third-party entity). In some instances, the feedback data may be utilized as training data to train (or re-train) one or more machine learning models, including, e.g., the RAG model 315, the recommendation model 320, the course template generator 325, another model utilized by the AI engine 310, or a combination thereof.

Accordingly, in some configurations, the AI engine 310 may facilitate or otherwise implement real-time (or near real-time) adaptation or personalization, as described in greater detail herein. For instance, as described in greater detail herein, the AI engine 310 may adapt course content, including course templates, in real-time (or near real-time), which may offer personalized learning paths for an individual learner user, a group of learner users, etc. For instance, when a student is struggling with a concept, the technology disclosed herein (e.g., via the AI engine 310) can dynamically adjust or revise a course template by automatically introduce supplementary materials, adjust a difficulty level of assessments, etc.

In one specific example, the AI engine 310 may generate a first course template for a group of learner users, where the group of learner users includes each student enrolled in a course. As part of the course, the learner users may take an assessment. Based on the results of the assessment (as feedback data for the AI engine 310), the AI engine 310 may generate a second course template (as a revised version of the first course template) for a subgroup of the learner users enrolled in the course, where the subgroup of learner users achieved a non-satisfactory score on the assessment (e.g., achieved a performance metric or score below a performance threshold indicating a certain proficiency or mastery level). Following this example, the AI engine 310 may generate the second course template such that the second course template includes supplementary material(s) directed towards a learning objective or topic of the assessment such that the subgroup of learner users may further develop their proficiency or mastery level of that learning objective or topic via interaction with the supplementary material(s). The learner user(s) that achieved a satisfactory score on the assessment (e.g., a performance metric or score above the performance threshold) may continue to follow the first course template. In some instances, the performance threshold may be a course criterion or preference set by the instructor user (e.g., included as user data 302 in a corresponding instructor profile 302B). While this example utilizes a performance metric relative to a performance threshold for determining groups of learner users, other attributes or characteristics may be utilized to group learner users.

Accordingly, in some instances, the AI engine 310 may generate a course template that is specific or personalized to an individual learner user. Alternatively, or in addition, the AI engine 310 may generate a course template that is specific or personalized to a specific group of learner users (e.g., a group of learner users in a particular course or a subset thereof).

In some configurations, the AI engine 310 may facilitate or otherwise implement predictive course design recommendations. For instance, in some configurations, the technology disclosed herein (e.g., via the AI engine 310) may employ predictive analytics to recommend future course design strategies, which may improve accessibility and awareness of educational trends, learner user needs, etc., for instructor users. In some examples, the technology disclosed herein (e.g., via the AI engine 310) may continuously analyses how an instructor user interacts with the system disclosed herein to identify common patterns with respect to interactions of the instructor user with the system disclosed herein. In one scenario, a first instructor might prefer using video activities having a short duration that have specific objectives included, as a preferred content. In another scenario, a second, different instructor may use textual or assessment-based activities for assignment creation. In either case, the next time either instructor conducts course creation, the technology disclosed herein (e.g., via the AI engine 310) may reference previous activity conducted and may recommend an appropriate design strategy. For example, with respect to the first instructor, the technology disclosed herein (e.g., the AI engine 310) may recommend video-based activities matching an instructor style of the first instructor, based on identified common patters for the first instructor, etc., which, in turn, may reduce overhead and research for the first instructor. As another example, the AI engine 310 may generate a course template prior to the corresponding course beginning. For instance, prior to a course starting, an instructor may request a course template for a particular course having a particular set of learner users enrolled. The AI engine 310 may generate the course template using the instructor preferences or criteria (e.g., user data 302 included in the instructor profile 302B of the instructor), the learning course content 306, or the user data 302 included in the learner profiles 302A for each learner user enrolled in the course.

While the AI engine 310, including the RAG model 315, the recommendation model 320, or the course template generator 325, are described herein as being included in the server(s) 102, in other examples, the AI engine 310, including the RAG model 315, the recommendation model 320, or the course template generator 325, may be stored in another remote device or cloud server, such as, e.g., the database(s) 110, the client communication device(s) 106, or the like, which is communicatively coupled to the server 102 over the communication network 120.

In some examples, the content assessment and development system 300 may interact with the client computing device(s) 106 via one or more communication network(s) 120. In some examples, the client computing device(s) 106 can include a display device 330 configured to provide a graphical user interface (GUI) 332 to display learning course content rendering(s) 335 (e.g., such as learning course content 306 pursuant to a course template, as generated using the AI engine 310 as described herein). In some examples, the GUI 332 may be generated in part by execution by the client communication device 106 of browser/client software 340 and based on data received from the system 300 (e.g., learning course content 306 pursuant to a course template generated by the AI engine 310) via the network 120.

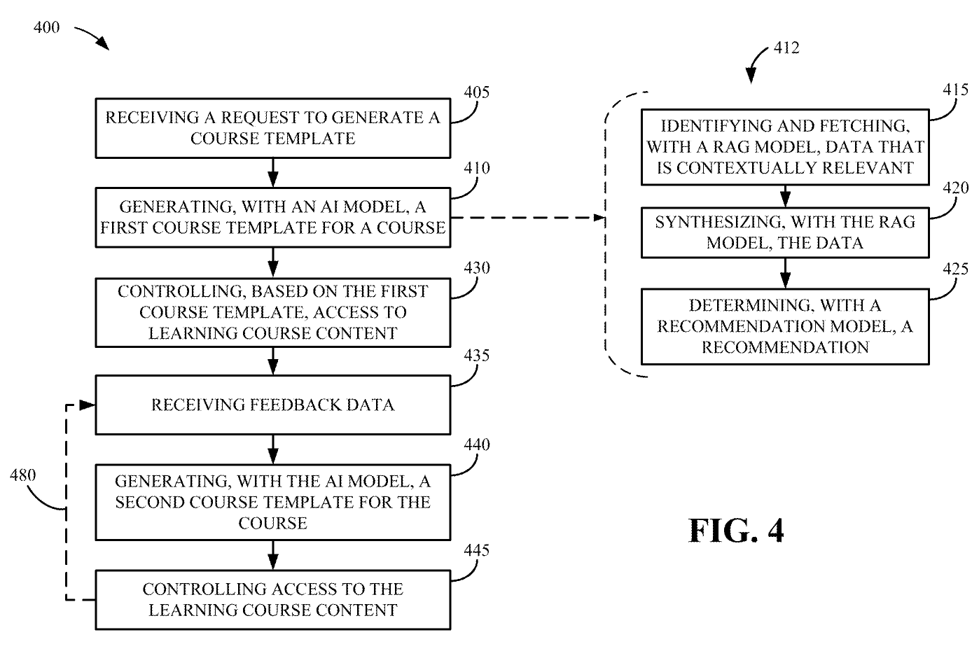

FIG. 4 illustrates an example method 400 for generating adaptive AI-based course templates using real-time (or near real-time) feedback, in accordance with various aspects of the techniques described in this disclosure. The method 400 is described herein as being performed by the server 102, and, in particular, the AI engine 310 when executed by the server 102. The flowchart of FIG. 4 utilizes various system components that are described below with reference to FIGS. 1-3. In some examples, the method 400 may be carried out by the server(s) 102 illustrated in FIG. 3, e.g., employing circuitry and/or software configured according to the block diagram illustrated in FIG. 2. In some examples, the method 400 may be carried out by any suitable apparatus or means for carrying out the functions or algorithm described herein. Additionally, although the blocks of the method 400 are presented in a sequential manner, in some examples, one or more of the blocks may be performed in a different order than presented, in parallel with another block, or bypassed. Also, in some configurations, one or more blocks of the method 400 may be repeated.

As illustrated in FIG. 4, the server 102 may receive a request to generate a course template for a course (at block 405). In some configurations, the server 102 may receive the request via the communication network 120 from the client communication device 106. In some examples, the request may originate at the client communication device 106. For instance, the request may be initiated by a user interacting with the client communication device 106. As one example, an instructor user may initiate, at the client communication device 106 of the instructor user, a request for a course template for a course that the instructor user will be instructing (or is presently instructing).

The request may include information related to the course, such as, e.g., an identifier or name of the course (e.g., an instructor-defined course name, an educational institution -defined course name, etc.), an identifier of an instructor of the course (e.g., an instructor name, a teaching assistant name, etc.), a class list (e.g., a list identifying learner users enrolled in the course, etc.), a class schedule (e.g., dates and times the class is scheduled to meet, etc.), a course type or category (e.g., a mathematics course, a science course, a literature course, a philosophy course, etc.), a course level (e.g., an introductory course, an advanced course, etc.), a course presentation type (e.g., in-person, virtual, etc.), a course location (e.g., a room number, a building name, etc.), etc.

The server 102 (e.g., the AI engine 310) may generate a course template for the course (at block 410). In some configurations, the server 102 may generate the course template responsive to receiving the request (e.g., at block 405). Alternatively, or in addition, the server 102 may generate a course template responsive to another type of triggering event, such as, e.g., a predetermined schedule (e.g., weekly, daily, bi-weekly, etc.), a completion of a predetermined event (e.g., upon completion of a unit or lesson of a course, upon completion of an assessment of a course, upon completion of a semester or quarter, etc.), etc. As noted herein, the technology disclosed herein may provide for adaptive AI-based course template generation using real-time (or near real-time) feedback. As such, in some configurations, the server 102 may generate a course template responsive to receipt of feedback data, as described in greater detail herein.

In some configurations, the server 102 may utilize or implement the AI engine 310 to generate the course template (e.g., at block 410). As noted herein, the AI engine 310 may include the RAG model 315, the recommendation model 320, the course template generator 325, etc. As such, in some instances, the server 102 may implement the RAG model 315, the recommendation model 320, the course template generator 325, or a combination thereof in order to generate a course template (represented in FIG. 4 by reference numeral 412).

In some examples, the server 102 may identify and fetch data (e.g., the user data 302, the learning course content 306, etc.) that is contextually relevant (at block 415). As described in greater detail herein, the server 102 may invoke (or otherwise execute) the RAG model 315 to identify and fetch data that is contextually relevant. For example, in some configurations, the RAG model 315, along with vector embeddings and semantic search techniques, may be utilized to ensure that the data is contextually relevant and semantically equivalent to the provided information. The data identified by the server 102 (e.g., at block 415) may include the user data 302 (or a portion thereof), including user data included in the learner profile(s) 302A, the instructor profile(s) 302B, etc., the learning course content 306 (or a portion thereof), other data accessible by the server 102, or a combination thereof. In some configurations, the sever 102 may identify data that is contextually relevant to the request (or information included therein). For example, when the request indicates a particular instructor user (e.g., the instructor user initiating the request or the instructor user that will be or is teaching the course), information related to the course (e.g., class list, etc.), etc., the server 102 may identify data that is contextually relevant to the particular instructor, the information related to the course, etc.

As such, in some instances, the server 102 (via, e.g., the RAG model 315) may fetch (or otherwise access) data from the database(s) 110, such as the user data 302, the learning course content 306, etc. In some configurations, the server 102 may utilize the RAG model 315 to fetch data that is contextually relevant, such as, e.g., data from across multiple locations or devices (e.g., the databases 110). As one example, when the request indicates a particular instructor user, the server 102 (via, e.g., the RAG model 315) may access the instructor profile 302B (e.g., the user data 302 included therein) for the particular instructor user, including, e.g., one or more course criteria, preferences, recordings, teaching styles, etc. for the particular instructor user. As another example, when the request indicates that the corresponding course is a sociology course, the server 102 (via, e.g., the RAG model 315) may access sociology related learning course content 306 from the database(s) 110, including, e.g., sociology related assessments, sociology related learning materials or sources, etc. As yet another example, when the request indicates a particular learner user (or group of learner users), the server 102 (via, e.g., the RAG model 315) may access one or more of the learner user profiles 302A (e.g., the user data 302 included therein).

As illustrated in FIG. 4, the server 102 may synthesize (via, e.g., the RAG model 315) the data (at block 420). The server 102 (via, e.g., the RAG model 315) may synthesize the relevant data (e.g., the user data 302, the learning course content 306, etc.) by integrating the relevant data in order to identify or determine relationships, patterns, or themes for the relevant data such that patterns of agreement, convergence, divergence, or discrepancy may be determined. For example, in some configurations, the server 102 may synthesize the relevant data to identify or determine one or more relationships among content chapters or sections and learning objectives, one or more instructors or students of a given course, one or more students facing challenges or achieving high scores, etc.

At block 425, the server 102 may utilize the recommendation model 320 to determine one or more recommendations or predictions based on the determined relationships, patterns, etc. (e.g., as determined by the RAG model 315). The recommendations or predictions may include, e.g., commonly selected assignments within a course, assignments categorized by difficulty, assignments tailored to student participation and performance metrics, etc. In some configurations, the server 102 may generate the course template (e.g., at block 410) based on the recommendation(s) or prediction(s) (e.g., as determined at block 425). As noted herein, in some instances, the server 102 may invoke (or execute) the course template generator 325 (e.g., of the AI engine 310) to generate the course template, as described in greater detail herein.

In some configurations, after the course template is generated (e.g., at block 410), the server 102 may control access to the learning course content 306 included in the course template (at block 430). In some instances, the server 102 may control access to the learning course content 306 by controlling the presentation or provisioning of the learning course content 306 to the client communication device(s) 106. For example, in some configurations, the server 102 may control the learning course content rendering 335 such that the learning course content rendering 335 provides (or enables access to) the learning course content 306 in compliance or adherence to the course template. As one example, when the course template indicates a particular learning objective, learning course content 306 directed to or related to the particular learning objective may be in compliance with or adherence to the course template. As another example, when the course template indicates an instructor user preference for weekly assessments, learning course content 306 that includes weekly assessments may be in compliance with or adherence to the course template.

Alternatively, or in addition, in some instances, the server 102 may control access to the learning course content 306 by controlling the transmission of the learning course content 306 to the client communication device(s) 106. For instance, the server 102 may access and transmit (or otherwise provide) the learning course content 306 included in the course template to one or more of the client communication devices 106. In some examples, the server 102 may transmit the learning course content 306 to the client communication devices 106 in a piecemeal fashion (e.g., gradually as a course progresses and a portion of the learning course content 306 is ready to be taught). For example, the server 102 may transmit one or more portions of the learning course content 306 to the client communication device 106 of a learner user as the learner user is ready to interact with those one or more portions of the learning course content 306 (as the learner user progresses through the course). Alternatively, in some instances, the server 102 may transmit the learning course content 306 as a whole to the client communication device(s) 106.

Alternatively, or in addition, in some instances, the server 102 may control access to the learning course content 306 by transmitting the course template to the client communication device(s) 106. The client communication device(s) 106 may request and access the learning course content 306 (e.g., from the database(s) 110) in accordance with the course template received from the server 102.

The server 102 may receive (or otherwise detect) feedback data (at block 435). As described herein, feedback data may include, e.g., additional information for one or more learner users (e.g., additional content usage patterns, performance metrics, qualitative feedback, etc.), one or more instructor users (e.g., additional instructor preferences, course criteria, or input), or a combination thereof. Alternatively, or in addition, in some configurations, the feedback may include additional, new, or modified learning course content 306 (e.g., a new assessment published by a third-party entity). Accordingly, in some instances, the feedback data may be associated with the course template (e.g., as generated at block 430), including, e.g., the learning course content 306 included therein.

In some configurations, the server 102 may generate a revised course template (e.g., a second course template) for the course based on the feedback data (at block 440). In some configurations, the server 102 may generate the revised course template as similarly described herein with respect to generating the course template at block 410 (e.g., the first course template). For instance, the server 102 may invoke (or otherwise execute) the AI engine 310 to generate the revised course template, as described herein for blocks 415, 420, and 425. While the second course template may be generated using a similar approach as the first course template, the AI engine 310 may incorporate the feedback data into its analysis (e.g., in addition to the data utilized when generating the first course template). In some configurations, after the second course template is generated (e.g., at block 440), the server 102 may control access to the learning course content 306 included in the course template (at block 445), as similarly described herein with respect to block 430.

As illustrated in FIG. 4 by the dashed arrow labeled with reference numeral 480, in some configurations, one or more of blocks 435, 440 (which may include, e.g., blocks 415, 420, 425), and 445 may be repeated, such as, e.g., responsive to receipt or detection of additional feedback data. As such, in some configurations, the server 102 (e.g., the AI engine 310) may generate a course template responsive to receipt of feedback data, as described in greater detail herein.

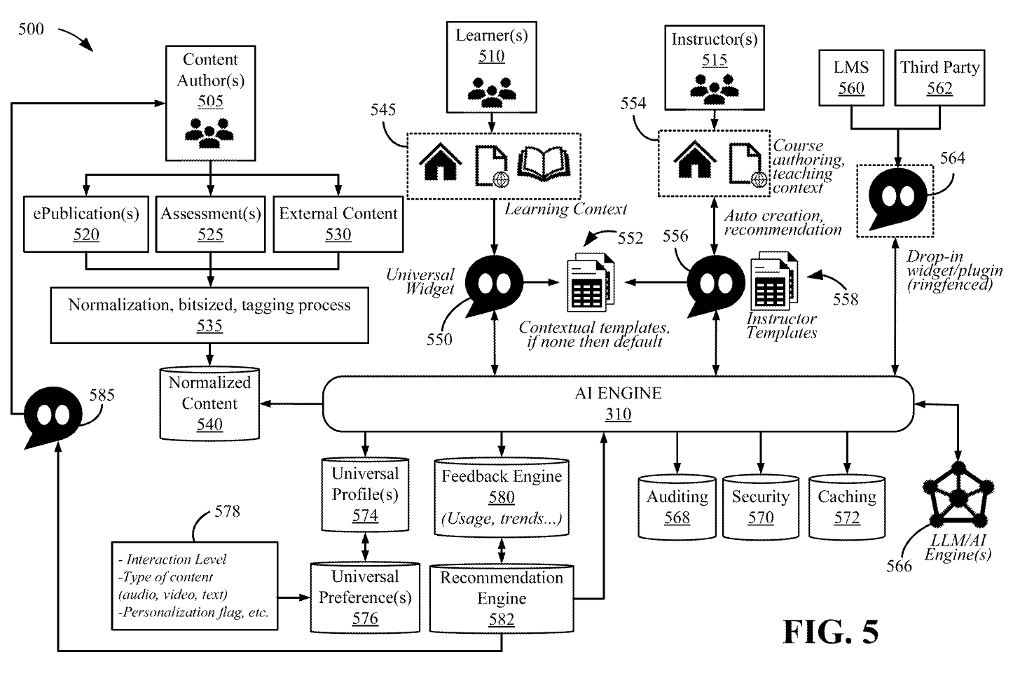

FIG. 5 illustrates another example system level block diagram 500 for providing the disclosed adaptive course template generation system architecture, in accordance with the technology disclosed herein. The example of FIG. 5 includes one or more content authors 505, one or more learners 510, and one or more instructors 515. The content author(s) 505 may author or develop learning course content (e.g., the learning course content 306), such as, e.g., one or more electronic publications (ePublications) 520, assessments 525, or other external content 530. In some instances, the content author(s) 505 may be third party content authors or developers. Alternatively, or in addition, in some instances, the content author(s) 505 may be an instructor (e.g., the instructor(s) 515). As illustrated in FIG. 5, the content developed or authored by the content author(s) 505 may undergo various processes, including, e.g., normalization, bit sizing, tagging, etc. (represented in FIG. 5 by reference numeral 535). In some instances, after undergoing the various processes, the content may be stored as normalized content in a database (e.g., as the learning course content 306 in the database(s) 110) (represented in FIG. 5 by reference numeral 540). As illustrated in FIG. 5, in some instances, the AI engine 310 may provide or otherwise store normalized content in the database 540.

As also illustrated in FIG. 5, the learner(s) 510 may interact with (via, e.g., the client communication device(s) 106) a learning context 545. In some instances, the learning context 545 may include a learning application or another software application (e.g., the browser/client software 340 of FIG. 3) that enables the learner(s) 510 to interact with the learning context 545, including, e.g., the learning course content rendering 335. In some instances, the learning context 545 may communicate (or otherwise interact with) a universal widget 550. In some examples, the learning context 545 may provide data (e.g., the user data 302 associated with the learner(s) 510 interacting with the learning context 545). The universal widget 550 may communicate with the AI engine 310, one or more contextual templates 552 (e.g., course templates generated by the AI engine 310, as described herein), or a combination thereof. In some instances, the universal widget 550 may facilitate the learning context 545 in accordance with, e.g., the one or more contextual templates 552. Alternatively, or in addition, the universal widget 550 may provide the data from the learning context 545 to the AI engine 310 (e.g., as feedback data, in some instances).

The instructor(s) 515 may interact with (via, e.g., the client communication device(s) 106) a course authoring or teaching context 554 (the “teaching context 554”). The teaching context 554 may be enable course instruction, course authoring, or a combination thereof. For example, the instructor(s) 515 may interact with the teaching context 554 by initiating a request for a course template, as described in greater detail herein. The teaching context 554 may be in communication with (or otherwise interact with) a widget 556. The widget 556 may enable auto creation of course templates, recommendations, or the like, such as, e.g., via communication with the AI engine 310. For instance, as illustrated in FIG. 5, the widget 556 may enable the teaching context 554 to access the contextual templates 552, one or more instructor templates 558, or a combination thereof.

In some examples, as illustrated in FIG. 5, the AI engine 310 may be in communication with a learning management system (LMS) 560 or a third party system 562 via a widget 564. For example, the LMS 560 may allow an instructor user to create or manage assignments in the context of their course from an LMS user interface via the widget 564. In some instances, the widget 564 may be a drop-in widget, a plugin, or the like. As also illustrated in FIG. 5, the AI engine 310 may be in communication with one or more large language models (LLMs) or other AI engines (represented in FIG. 5 by reference numeral 566). The AI engine 310 may be in communication with various components for auditing, security, or caching (represented in FIG. 5 by reference numerals 568, 570, and 572, respectively). The AI engine 310 may access or otherwise retrieve one or more universal profiles stored in a database (e.g., the database(s) 110) (represented in FIG. 5 by reference numeral 574). The universal profiles stored in the database 574 may be generated or based on one or more universal preferences (represented in FIG. 5 by reference numeral 576). Example universal preferences may include, e.g., interaction level, type of content (e.g., audio, video, text), personalization flag, etc. (represented in FIG. 5 by reference numeral 578). The AI engine 310 may communication or otherwise interact with a feedback engine (represented in FIG. 5 by reference numeral 580). The feedback engine 580 may interact with a recommendation engine 582 (e.g., the recommendation model 320 of FIG. 3). As illustrated in FIG. 5, the recommendation engine 582 may communicate with the AI engine 310 and a widget 585, which may interact with the content author(s) 505.

Accordingly, as noted herein, the technology disclosed herein may provide for adaptive AI-based course template generation using real-time (or near real-time) feedback. For instance, in some configurations, the AI engine 310 may facilitate or otherwise implement real-time (or near real-time) adaptation or personalization, as described in greater detail herein. For instance, the AI engine 310 may adapt course content, including course templates, in real-time (or near real-time), which may offer personalized learning paths for an individual learner user, a group of learner users, etc. For instance, when a student is struggling with a concept, the technology disclosed herein (e.g., via the AI engine 310) can dynamically adjust or revise a course template by automatically introduce supplementary materials, adjust a difficulty level of assessments, etc.

The technology disclosed herein may enhance learning outcomes by providing personalized experiences, improving comprehension and retention for learners. The technology disclosed herein may increase accessibility to education by catering to diverse learning needs and abilities. Educators benefit from data-driven insights, enabling them to improve teaching strategies and professional development. The technology disclosed herein provides for scalability across various educational offerings, disciplines, and platforms, from K-12 to professional training, which amplifies its impact. With its ability to automatically create assignments and questions, the technology disclosed herein provides a significant competitive edge in the educational technology market. The technology disclosed herein provides advanced personalization that enhances learning outcomes by tailoring content to individual student needs. The technology disclosed herein advantageously improves efficiency in automating course design as well as improving quality and performance of automated course design. which reduces educators' workload, a major advantage for institutions. The technology disclosed herein aligns with trends towards online and blended learning, and, as such, the technology disclosed herein meets a demand in modern education while also enhancing student engagement and satisfaction.

Additionally, the technology disclosed herein also addresses privacy concerns related to student data, including, e.g., maintaining trust and compliance with educational standards and regulations. The technology disclosed herein provides a technical improvement in data security as it relates to the privacy concerns of student data as the technology disclosed herein provides for a more personalized and efficient learning environment while also maintaining trust and compliance with educational standards and regulations related to student data privacy concerns. Additionally, the technology disclosed herein aligns with an evolving need of modern education by enhancing the reachability of quality content through recommendation as well as reducing manual steps for authoring the course, which in turn improves outcomes for the students and maintains privacy of a student’s data.

While the technology disclosed herein is generally described with reference to a classroom environment (physical or virtual) (e.g., within the education sector or industry), the technology disclosed herein may be implemented to other environments, industries, or sectors. As one example, the technology disclosed herein may be implemented within a corporate environment, such as, e.g., for corporate training. In such implementations, the technology disclosed herein may personalize employee development programs. The technology disclosed herein is suitable for professional certification and continuing education, adapting to varied professional expertise levels. As another example, in the healthcare sector, the technology disclosed herein may provide customized training for medical staff, as the technology disclosed herein may accommodate rapidly evolving medical knowledge. As yet another example, the technology disclosed herein may be implemented in a government sector. For instance, a government agency or entity may implement the technology disclosed herein for diverse training needs in civil services, law enforcement, the military, etc. As yet another example, the technology disclosed herein may be implemented within personal development applications, supporting self-directed learning across various fields.

Other examples and uses of the disclosed technology will be apparent to those having ordinary skill in the art upon consideration of the specification and practice of the technology disclosed herein. The specification and examples given should be considered as examples only, and it is contemplated that the appended claims will cover any other such embodiments or modifications as fall within the true scope of the inventions.

The Abstract accompanying this specification is provided to enable one to determine quickly from a cursory inspection the nature and gist of the technical disclosure and in no way intended for defining, determining, or limiting the present inventions or any of its embodiments.

What is claimed:

1. A system for implementing adaptive artificial intelligence-based course template generation, the system comprising:
a processing system including one or more electronic processors, the processing system configured to:
receive a request to generate a first course template for a course;
identify, with an artificial intelligence (AI) engine, user data that is contextually relevant to the request;
synthesize, with the AI engine, the user data to determine a set of patterns for the user data;
generate, with the AI engine, a set of recommendations based on the set of patterns;
generate, based on the set of recommendations, a first course template for the course;
generate a first set of learning course content that adheres to the first course template for the course; and
transmit, via a communication network, the first set of learning course content to a client device for display as a learning course content rendering via a graphical user interface.

2. The system of claim 1, wherein the AI engine includes:
a retriever-augmented generation (RAG) model configured to identify the user data that is contextually relevant to the request and synthesize the user data to determine the set of patterns for the user data; and
a recommendation model configured to generate the set of recommendations based on the set of patterns.

3. The system of claim 1, wherein the processing system is configured to:
receive feedback data associated with the first set of learning course content;
generate, with the AI engine, a second course template for the course based on the feedback data;
generate a second set of learning course content that adheres to the second course template for the course; and
transmit the second set of learning course content for display.

4. The system of claim 3, wherein the second course template is different from the first course template, and the first course template and the second course template comply with the same learning objective of the course.

5. The system of claim 3, wherein the feedback data includes learner user data for a learner user of the course, the learner user data including at least one of data describing an interaction of the learner user with the first set of learning course content, a performance metric of the learner user, or qualitative feedback provided by the learner user.

6. The system of claim 3, wherein the feedback data includes instructor user data for an instructor user of the course, the instructor user data including a preference of the instructor user.

7. The system of claim 3, wherein the second course template includes additional course content not included in the first course template.

8. The system of claim 3, wherein the processing system is configured to transmit the first set of learning course content to a first client device of a first learner user and a second client device of a second learner user, and, when the feedback data indicates that the second learner user achieved a performance metric below a performance threshold, transmit the second set of learning course content to the second client device of the second learner user, wherein the second set of learning course content includes supplemental course content.

9. The system of claim 1, wherein the processing system is configured to:
develop and maintain a plurality of learner user profiles, each learner user profile of the plurality of learner user profiles being specific to a specific learner user and including at least one of learner user interaction data, performance metric data, or qualitative feedback data.

10. The system of claim 1, wherein the user data includes a course criterion established by an instructor user of the course, and wherein the processing system is configured to determine an impact of the course criterion on one or more learner users of the course.

11. The system of claim 1, wherein the user data includes a recording of an instructor user of the course, and wherein the processing system is configured to generate the course template based on the recording and generate, on a personalized basis for a learner user, the first set of learning course content based on the recording to emulate a teaching style of the instructor user.

12. The system of claim 1, wherein, when the request identifies a first learner user, the user data includes user data included in a learner profile of the first learner user and the first course template is generated for a first learner user such that the first course template is personalized for the first learner user.

13. The system of claim 1, wherein, when the request identifies a group of learner users, the user data includes user data included in a plurality of learner profiles for the group of learner users and the first course template is generated for the group of learner users such that the first course template is personalized for the group of learner users.

14. A method of implementing adaptive artificial intelligence-based course template generation, the method comprising:
receiving, with a processing system including one or more electronic processors, while a course is in progress, data associated with a first set of learning course content for the course, the first set of learning course content adhering to a first course template for the course, the first course template generated using an artificial intelligence (“AI”) engine;
providing, with the processing system, the data to the AI engine in order to determine a recommended course template modification;
generating, with the processing system, using the AI engine, a second course template for the course based on the recommended course template modification;
generating, with the processing system, a second set of learning course content that adheres to the second course template for the course; and
transmitting, with the processing system via a communication network, the second set of learning course content to a client device for display as a learning course content rendering via a graphical user interface.

15. The method of claim 14, further comprising:
identifying, with a retriever-augmented generation (RAG) model of the AI engine, user data that is contextually relevant;
synthesizing, with the RAG model of the AI engine, the user data;
determining, with the RAG model of the AI engine, a set of patterns for the user data; and
generating, with a recommendation model, a set of recommendations based on the set of patterns, the set of recommendations including the recommended course template modification.

16. The method of claim 14, wherein generating the second course template includes generating a second course template that is different from the first course template, wherein the first course template and the second course template comply with a course criterion established by an instructor user of the course.

17. A non-transitory, computer-readable medium storing instructions that, when executed by a processing system including one or more electronic processors, perform a set of functions, the set of functions comprising:
receiving a request to generate a first course template for a course;
generating, using an artificial intelligence (AI) engine, a first course template for the course, the first course template identifying a first set of learning course content that adheres to the first course template for the course;
transmitting the first set of learning course content for display as a learning course content rendering via a graphical user interface;
receiving feedback data associated with the first set of learning course content;
generating, with the AI engine, a second course template for the course based on the feedback data, the second course template identifying a second set of learning course content that adheres to the second course template for the course; and
transmitting the second set of learning course content for display.

18. The computer-readable medium of claim 17, wherein generating the first course template for the course by:
identifying, with a retriever-augmented generation (RAG) model of the AI engine, user data that is contextually relevant to the request;
synthesizing, with the RAG model, the user data to determine a set of patterns for the user data; and
generating, with a recommendation model of the AI engine, a set of recommendations based on the set of patterns.

19. The computer-readable medium of claim 17,
wherein transmitting the first set of learning course content includes transmitting the first set of learning course content to a first client device of a first learner user of the course and a second client device of a second learner user of the course, and
wherein transmitting the second set of learning course content includes, when the feedback data indicates that the second learner user achieved a performance metric below a performance threshold, transmitting the second set of learning course content to the second client device of the second learner user, wherein the second set of learning course content includes supplemental course content.

20. The computer-readable medium of claim 17, wherein generating the second course template includes generating a second course template that is different from the first course template, wherein the first course template and the second course template comply with a course criterion established by an instructor user of the course.
